(19) United States
(12) Patent Application Publication
(10) Pub. No.: US 2007/0188959 A1
(43) Pub. Date: Aug. 16, 2007

(54) Electronic element adapted to an electric circuit arrangement

(76) Inventors: John Akerlund, Lidingo (SE); Jan Ottosson, Skarholmen (SE)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/596,350

(22) PCT Filed: May 23, 2005
(86) PCT No.: PCT/SE05/00762

§ 371 Date: Nov. 14, 2006

(30) Foreign Application Priority Data
May 25, 2004 (SE) 0401321-5

(51) Int. Cl. H02H 9/02

(52) U.S. Cl. 361/93.1

(57) ABSTRACT

The present invention comprises an electronic element (2a), fitted or adapted for an electric circuitry or circuit arrangement (1), where said circuitry inter alia is constituted by a voltage source (1a, 1b), a supply voltage and a current feeding unit (2) switching on or switching off a load, and an interlocking circuit (2a) connected between the unit and the load (1c), where said interlocking circuit is assigned a function fitted or adapted for switching on or switching off current, in order to achieve a switch-on or switch-off free from sparks or arcs of the load current (“Ib”) of a selected load (1c) via said element (2a). Said interlocking circuit is structured as an electronic element where a switch-on of voltage to said electronic element (2a) causes the activation of circuits belonging to the element in order to, after the switch-on of voltage and by a trigger signal, cause the load current (“Ib”) to said load (1c) to be increased. Furthermore, the invention comprises an electronic tripping or fusing element.

### TECHNICAL FIELD OF THE INVENTION

In the first place, the present invention relates to an electronic element, suited for and adapted to an electric circuit arrangement, where said circuitry or arrangement inter alia comprises a voltage source, a supply voltage and a supply current for feeding a unit, switching in or switching off a load, and an “interlocking” circuit, connected between the unit and the load.

Said “interlocking” circuit is assigned a function fitted for or adapted for switching on or switching off current, in order to produce a switch-on or switch-off sequence, free from sparks or arcs, caused by the load current to a selected load via said unit.

In the second place, the present invention relates to an electronic tripping or fusing element in the form of an over-current protection, wherein an electronic circuitry used for this purpose inter alia comprises a voltage source, a supply voltage and a supply current for a unit switching on or switching off a load, and a tripping or fuse element connected within the circuitry in a known way.

Regarding the recommended use of the present invention, it should be said that it is specifically fitted or adapted for work with an alternating voltage, a direct current voltage and/or both of them.

Appliances and circuits connected to an alternating voltage supply network are normally furnished with circuits which can be operated by means of alternating voltage only or alternating current only.

Apparatuses and circuits connected to a direct current voltage supply network are normal furnished or adapted with circuits which can be operated via direct current voltage only or direct current only.

However, apparatuses and circuits fitted or adapted for an alternating voltage supply as well as a direct current voltage supply are previously known, and such apparatuses are named “universal current apparatuses”.

In the first above said application, the invention is, among other things, suited or adapted for use in a plug, such as an adapter cord, and, in general, for use in a distribution of electricity via alternating voltage or direct voltage, then specifically fitted for the distribution of electricity and for electric installation within buildings, such as for a distribution of electricity fitted for “universal current apparatuses”.

“Universal current apparatuses” means that an installation and the appliances or apparatuses related to it are designed to work or function equally well either by use of direct current or alternating current or voltage.

Accordingly, the purpose of the invention is to increase the robustness of the distribution electricity by making possible the integration of UPS installations for direct current in e g the ordinary electric installation within a building.

The invention is intended to be designed with small outside or outer dimensions, e g for use in a plug for universal current, which may be used when an appliance cord is permanently connected to an appliance or apparatus. Furthermore, a universal current adapter cord can be used when a connecting cord is separate and is furnished with a plug for the appliance as well.

Due to its small outside or outer dimensions, the electronic element can be integrated in switch, e g a wall-mounted switch, and is intended to, in a version with a circuit arrangement adapted for the purpose, act as an electronic tripping or fusing element in the form an over-current protection etc.

### PRESENT STATE OF TECHNOLOGY OR ART

Electricity supply companies mainly distribute alternating voltage and alternating current to electricity consumers, however without providing guarantee against power outage and without supply of any reserve power in such situations of power outage.

Certain electricity consumers, whose operation is critical and important for the community such as telephone companies, hospitals and owners of buildings with extensive internet access and data networks and others, usually arrange their reserve power and uninterrupted power supply themselves by use of reserve power units or via alternating current powered UPS systems with a battery back-up.

A possibility of using universal current in such electricity supply networks would mean that a simpler, more flexible, more reliable and cheaper UPS solution could be used.

Such a possibility has become increasingly interesting in recent time, as nowadays virtually all loading objects have been given universal current properties and are able to accept an alternating current as well as a direct current power supply.

An adaptation to universal current could significantly increase the flexibility and robustness of the use and distribution of electricity, and, accordingly, the robustness of the community as a whole.

By this solution, building owners are enabled to supply electric power with integrated reserve power in the building through a separate direct current electricity supply network, which, together with the ordinary electricity supply network, can supply universal current as an extra high level of availability for critical purposes. Most of the appliances or apparatuses can be freely moved between the two networks.

Principles for the achievement of a spark-free switch-on or switch-off or interruption of an alternating current or direct current that can be connected to a load, are widely known, by the sizing purpose and application has resulted in rather large exterior size of the devices.

The present invention is adapted to, in an advantageous way, be incorporated in common electric installation supplies, in plugs and cords, in circuit breakers, in wall-mounted switches and, as an alternative, be used as an over-current protection, all of which are to be regarded as new features in addition to the former state of technology.

Thus, to the former state of technology belongs the presence of an interlocking circuit, which has been assigned, in itself or separately, a function fitted or adapted for switching on current (closing a current circuit) or switching off current (interruption of current flow), in order to achieve a switch-on and switch-off of the load current related to selected load, free from sparks and arcs, via said unit.

Thus it is known, first to make a voltage feeding unit manually activated and, after that, make an interlocking circuit, in the form of a switch, manually activated, in order to instantaneously connect the load current, with an occurring formation of sparks moved from the voltage supplying unit to said circuit and switch.

In addition, the content of the following patent publications is part of the former state of technology or art.

Thus, the patent publication U.S. Pat. No. 5,426,552 describes an electric outlet with a built-in safety arrangement.

A sensor circuit is fitted to cause a detection, whether the plug, in its true plugged-in position, is entirely put in or pulled out.

When the plug is put in, the current from the electricity supply network is fed to the connected load, and when the plug is pulled out, the current to the load is interrupted and the electric outlet becomes currentless (see column 2 line 14 up to and including column 5 line 12).

The patent publication FR-A1-2 704 686 describes an arrangement to make a point of distribution, such as an electric outlet, become safe.

The outlet is insulated from the electricity supply network or other source, and when a sensor detects that a load is connected, the electricity supply network is connected (see summary and FIG. 2).

The patent publication U.S. Pat. No. 5,267,116 also presents a safety arrangement for an electric outlet.

Also in this case there is a switching element detection, whether a plug is fully put in, and not until then the electricity supply network is connected and the load is supplied with a current (see column 1 line 48 up to and including column 3 line 24).

### TECHNICAL PROBLEM

The community of today tends to become increasingly vulnerable and dependent on supply of electricity at a very high level of availability, in some cases entirely free from interruption, and there are technical challenges involved in meeting this level of ambition.

For instance, a field of application, which is expected to retain its function, independent of supply of electricity from the ordinary electricity supply network, is telecommunication and data communication.

Accordingly, it is important to make an increased public use of different UPS solutions in the community safe, simple and cheap. An enlarged use of direct current and alternating current (universal current) for these purposes meets this need and solves the associated technical problems.

The crucial technical problem related to the use of direct current voltage and direct current is, and has always been, the difficulties appearing when the direct current is to be switched off and where it is required that the switching off shall take place without the formation of sparks and/or arcs in plugs, in switches and in over-current protections, particularly at high direct current voltage and high power.

For direct current distribution, this implies a significant risk of fire and great wear of contact parts in switches, and consequently great maintenance demand high maintenance cost for the installations if measures are not taken in order to restrain the formation of sparks and arcs.

When alternating current is used, the technical problems with the formation of sparks and arcs become less significant as the alternating current is characterized by consecutive zero crossings, that change the direction of current and thus present prerequisites for making the spark extinguished by the change of polarity.

Small-scale generation of alternating current by use of inverters powered by batteries in alternating current powered UPS installations is however expensive, complicated and maintenance-demanding.

If direct current in public use could be switched off in a safe and cheap way, direct current and universal current could be used for critical activities in the community instead of alternating current only.

Electronic, semiconductor-based switch elements for use in common electric installation supplies have so far been too space requiring, complicated and expensive to manufacture.

Another important reason for this state of circumstances is that the employed electronic circuits need internal control voltages which have to be generated in specific circuits forming electronic voltage producing units, and these become expensive and complicated, particularly within systems and appliances suited for high voltage.

There is a technical problem in understanding the importance of, the advantages associated with and/or the technical considerations that are required to, in the case of an electronic element, fitted or adapted for an electric circuitry or circuit arrangement, where said circuitry inter alia is constituted by a voltage source, a supply voltage and a current feeding unit switching on or switching off a load, and an interlocking circuit connected between the unit and the load, where said interlocking circuit is assigned a function suited for switching on or switching off current, in order to achieve a switch-on or switch-off, free from sparks or arcs, of the load current of a selected load via said unit, make the interlocking circuit structured as an electronic element, where an initial switch-on of voltage to said electronic element causes an activation of circuits belonging to the element in order to, after the switch-on of voltage and by a trigger signal, cause the load current to said load to increase as a function of time.

There is a technical problem in understanding the importance of, the advantages associated with and/or the technical considerations that are required to have said interlocking circuit and its electronic element fitted to or adapted to cause the circuits belonging to the element to be inactivated in order to, after a trigger signal, cause a reduction of the load current to said load before said unit causes the voltage supply to be switched off.

There is a technical problem in understanding the importance of, the advantages associated with and/or the technical considerations that are required to have said unit, switching on or switching off a voltage and, after that, a current to a load, fitted to or adapted to offer a step-wise switch-on or switch-off of current, in at least two steps.

There is a technical problem in being able to understand the importance of, the advantages associated with and/or the technical considerations that are required to, before the switch-on of a current, cause an activation of a first step, fitted to or adapted to, by a small auxiliary current (selected to have a value safely below a value that might cause a clearly detectable spark or arc) cause the activation of circuits belonging to the element and after that, via a trigger signal, cause the activation of a second step, fitted to or adapted to cause the load current to said load to be increased as a function of time.

There is a technical problem in understanding the importance of, the advantages associated with and/or the technical considerations that are required to, at a desired switch-off of the load current, have a first step activated, fitted to r adapted to inactivate circuits belonging to the element, the circuits being fitted to or adapted to cause a reduction as a function of time of the load current to said load towards the value zero and, after that, cause the activation of a second step, fitted to or adapted to switch off the supply voltage and the auxiliary current.

There is a technical problem in understanding the importance of, the advantages associated with and/or the technical considerations that are required to make the advantages of the present invention be evident, i e that the supply voltage should be selected to be less than 1000 V for A.C. or 1500 V for D.C.

There is a technical problem in understanding the importance of, the advantages associated with and/or the technical considerations that are required to make the circuits belonging to the element suited to or adapted to offer the assigned functions, no matter whether the electricity supply network is a direct current network or an alternating current network, thus via what is called universal current.

There is a technical problem in understanding the importance of, the advantages associated with and/or the technical considerations that are required to have said circuits belonging to the element comprise, in a direct current application, a semiconductor element connected in series, such as a transistor element with low internal resistance.

There is a technical problem in understanding the importance of, the advantages associated with and/or the technical considerations that are required to have said circuits belonging to the element comprise, in an alternating current application, two series connected semiconductor elements, such as two transistor elements with suitable, low internal resistance.

There is a technical problem in understanding the importance of, the advantages associated with and/or the technical considerations that are required to have an electronic element, fitted for or adapted for an electric circuitry or electric circuit arrangement and being part of that circuitry, comprising;
a. a voltage source,
b. a switch unit, suited for switching on or, alternatively, switching off of a load current to a load,
c. said load,
d. an interlocking circuit, which, at a desired switch-on of the load and being voltage supplied by means of an auxiliary current, is fitted to control an increasing load current, in order to reduce the formation of sparks otherwise occurring in switching units and
e. an interlocking current, which, at a desired switch-off of the load and being voltage supplied by means of an auxiliary current, is fitted first to cause inactivation of said circuit in order to cause a successive reduction of the load current towards and to a zero level and, after that, cause a switch-off of the supply voltage,
   and make the interlocking circuit comprise at least one MOSFET transistor, whose anode and cathode terminals are connected in series to said load and where an activating control signal shall be connected to the gate terminal of said transistor.

There is a technical problem in understanding the importance of, the advantages associated with and/or the technical considerations that are required to make said activating control signal or trigger signal be produced via a diode, connected in series with a resistor and a control unit.

There is a technical problem in understanding the importance of, the advantages associated with and/or the technical considerations that are required to make a control unit comprise a circuit with a capacitor, a zener diode and a resistor connected in parallel, the circuit being connected in series with a resistor and a control device.

There is a technical problem in understanding the importance of, the advantages associated with and/or the technical considerations that are required to have said control device for the production of a trigger signal be connected between said parallel connected circuit and a gate terminal.

There is a technical problem in understanding the importance of, the advantages associated with and/or the technical considerations that are required to make it possible that said supply voltage may be an alternating voltage and that the control unit shall then control and/or comprise two semiconductor elements connected in series, such as transistors, and then specifically MOSFET transistors, whose anode and cathode terminals are connected in series with said load, while the cathode terminal of one of the transistors shall be connected to the cathode terminal of the other transistor.

There is a technical problem in understanding the importance of, the advantages associated with and/or the technical considerations that are required to, after a trigger signal, cause the current to be increased to its maximum value, by assigning that a semiconductor element, such as an IGBT transistor, shall be connected in parallel with a semiconductor element, such as a MOSFET transistor, assigned to said IGBT transistor.

There is a technical problem in understanding the importance of, the advantages associated with and/or the technical considerations that are required to have the interlocking circuit suited or adopted not to require a particular internal voltage supply unit producing necessary control voltages for the employed semiconductor elements.

There is a technical problem in understanding the importance of, the advantages associated with and/or the technical considerations that are required to make the activation or inactivation of the interlocking circuit caused by an internal or external sensor, the sensor or sensors suited to or adapted to cause the detection, whether a unit is switched on or switched off, or, alternatively, shall be arranged to have it determined whether a feeding current shall be switched on or switched off via other criteria.

There is a technical problem in understanding the importance of, the advantages associated with and/or the technical considerations that are required to have said sensor suited to or adapted to comprise an electronic circuit and/or a computer unit, with an appurtenant possibility of communication for generation of a trigger signal.

There is a technical problem in understanding the importance of, the advantages associated with and/or the technical considerations that are required to have said unit consist of a connecting device, such as a plug, a cord with a plug at each end, or a switching device, such as a breaker, a switch or an over-current protection, within an electronic tripping or fusing element.

There is a technical problem in understanding the importance of, the advantages associated with and/or the technical considerations that are required to make the interlocking circuit adaptable to be, free of choice, furnished with an interference protection, a transient protection and/or an EMI filter.

Furthermore there is a technical problem in being able to understand the importance of, the advantages associated with and/or the technical considerations that are required to use a circuitry or a circuit arrangement as above and, additionally, supplement a used electronic circuitry as an electronic tripping or fusing element in the form of an over-current protection.

### THE SOLUTION

The present invention is based on an electronic element, fitted for or adapted for an electric circuitry or electric arrangement, where said circuitry inter alia is constituted by a voltage source, a supply voltage and a current feeding unit, switching on or switching off a load, and an interlocking circuit connected between the unit and the load, the interlocking circuit being assigned a function suited for or adapted for switching on or switching off current in order to create or form a switch-on and switch-off, free from sparks or arcs, of the load current of a selected load via said unit.

In order to solve one or more of the above said technical problems, the invention particularly assigns that said interlocking circuit shall be structured as an electronic element and that a switch-on of voltage to said electronic element shall activate circuits belonging to the element in order to, after a switch-on of voltage and an activated trigger signal, cause an increase as a function of time of the load current to said load.

Furthermore, said interlocking circuit and its electronic element are suited to or adapted to cause an inactivation of circuits belonging to the element in order to, after an activated trigger signal, cause a reduction of the load current to said load towards zero level before said unit causes the supply of voltage and the necessary auxiliary current to be switched off.

As suggested ways of implementation, associated with the present invention, it is assigned that said unit, switching on or switching off voltage and current to a load, shall be adapted to offer a step by step switch-on or step by step switch-off of current, in at least two steps.

For the switch-on of current a first step is activated, adapted to, by means of a supply voltage and an utterly low auxiliary current, cause an activation of circuits belonging to the element, and after that, a second step is activated by a trigger signal, the second step being fitted or adapted to cause an increase as a function of time of the load current to said load.

For switching off the load current a first step is activated, fitted to or adapted to, by a trigger signal, inactivate circuits belonging to the element, fitted or adapted to cause a reduction as a function of time of the load current to said load towards zero level, and after that, a second step is activated, fitted to or adapted to switch off the supply voltage and the auxiliary current.

In particular, it is assigned that the selected supply voltage should be selected to be less than 1000 V for A.C. and 1500 V for D.C. and that the circuits belonging to the element shall be fitted to or adapted to offer the assigned functions via what is called universal current.

Furthermore, it is assigned that said circuits belonging to the element shall incorporate, in a direct current application, a semiconductor element, such as a transistor element with low internal resistance, connected in series between the supply voltage and the load.

Said circuits belonging to the element shall incorporate, in an alternating current application, two semiconductor elements, such as two transistor elements with suitable, low internal resistance, connected in series as above.

For an electronic element, fitted for and adapted for an electric circuitry or circuit arrangement, where said circuitry comprises:
a. a voltage source
b. a switching unit, designed for switching on or switching off of a load
f. said load
g. an interlocking circuit, which, at switch-on of the load and being voltage fed and by means of an auxiliary current, is fitted to or adapted to cause the control of an increasing load current in order to reduce the formation of sparks otherwise occurring in switching units and
h. an interlocking circuit, which, at switch-off of the load and being voltage fed and by means of an auxiliary current, is fitted or adapted first to cause an inactivation of said circuit in order to cause a successive reduction of the load current and, after that, cause the supply voltage to be switched off,
   the invention assigns that said interlocking circuit shall comprise at least one MOSFET transistor, whose anode and cathode terminals are connected in series with said load and where an activating control signal is connected to the gate terminal of said transistor.

Said activating control signal is generated via a diode, connected in series with a resistor and a control unit.

A control unit comprises a capacitor, a zener diode and a resistor connected in parallel, and is connected in series with a resistor and a control device.

Said control device is connected between said control unit and a gate terminal.

Said supply voltage is an alternating voltage, and the control unit comprises two MOSFET transistors connected in series, with the anode and cathode terminals connected in series with said load, while the cathode terminal of one transistor is connected to the cathode terminal of the other.

In particular, it is assigned that an IGBT transistor shall be connected in parallel with a MOSFET transistor assigned to said IGBT transistor.

The interlocking circuit is fitted not to require a particular internal voltage producing unit for generation of necessary control voltages for the employed semiconductor elements.

The interlocking circuit shall be activated or inactivated by a sensor or sensors, which sensor or sensors are fitted to cause a detection whether a unit is switched on or switched off, or, alternatively, are fitted or adapted to cause a determination, via other criteria, whether a feeding current shall be switched on or switched off.

Said sensor is fitted to comprise an electronic circuit and/or a computer unit with appurtenant possibility of communication.

Said unit consists of a connecting device, such as a plug, a cord with a plug at both ends, or a switching device, such as a breaker, a switch, or an over-current protection within an electronic tripping or fusing arrangement.

The interlocking circuit is adaptable to be furnished, free of choice, with an interference protection, a transient protection and/or an EMI filter.

By use of a simple circuitry and by a control of the switch element, that does not require internal and separate voltage producing unit circuits for control and electronics, a semiconductor element can be made so cheap and simple that it can be incorporated in common installation supplies.

Additionally, the invention assigns that it shall be possible to furnish a common plug with a resilient contact device or, alternatively, a magnet, a micro switch or other sensor or arrangement in the contact device, that control electronic circuits in the plug when the plug is being put in or pulled out from e g a wall socket, which is certified for and adapted for alternating current as well as direct-current, i e universal current.

This wall socket could then have a mechanical stop in order to prevent the insertion of other plugs not intended for universal current.

Thus, in this implementation, the wall socket contacts are polarized so that plus and minus always remain in the same position.

When the plug has been put in to its bottom position in the socket, the micro switch activates a semiconductor element via a trigger signal, so that a direct current or alternating current, relevant to the load, is let through.

When the plug is being pulled out from the socket, the micro switch trips for generation of a trigger signal before the current-conducting pins of the plug lose the mechanical and electric contact with the female contact elements of the socket.

This tripping controls the semiconductor elements so that the current is cut out by the electronics before the plug is separated from the socket. By that, no spark from a switch-off of current can arise.

In a cord with connecting plugs at both ends, a micro switch is mounted also in the other plug, and control wires for the electronics are integrated in the cord, so that the current is switched off when one of the plugs is pulled out from its contact position.

Beside the above suggested use and application in plugs, appliance or apparatus cords and cable connectors with a contact device at each end, the contrivance also can be employed in switches, circuit closers, tripping or fusing elements in the form of an over-current protection, branching-off boxes, extension cords and other electric appliances and apparatuses intended for universal current.

The unit in accordance with the invention also can be implemented in an outlet device, such as a wall socket outlet.

As this then always has to be sized for higher current than the current value required for a plug intended for one or a few appliances only, such a possible implementation will be more expensive and difficult to introduce.

The description of the solution in these parts presupposes an implementation within the plug concept.

The invention also offers an electronic tripping or fusing element in the form of an over-current protection, fitted or adapted to an electric circuitry, where said electric circuitry comprises inter alia a voltage source, a supply voltage and a supply current to a unit switching in or switching off a load, and said over-current protection.

In this case, the over-current protection may comprise at least one semiconductor element, such as one or more MOSFET transistors, whose anode and cathode terminals are connected in series with said load via a resistor generating the trigger signal, and where said activating control or trigger signal is connected to the gate terminal of the semiconductor element.

### ADVANTAGES

The suggested solutions have the advantage that all distribution of electricity from different sources of alternating voltage and direct-current voltage is facilitated. Furthermore, sources of alternating voltage as well as direct current voltage can be connected to the same distribution system without emergence of conflict or difficulties.

No formation of sparks (or at least utterly small formation of sparks) can arise when current is switched on to a load or at a switch-off or cut out.

This property or condition is an advantage also when a switch-on or switch-off free from sparks and arcs of electric appliances or apparatuses is desired for reasons of interference or safety, e g in environments with explosion hazard.

Very high availability can be achieved in systems for uninterrupted power supply, which increases the possibility of supplying electric power at an extra high level of availability and reliability.

By the suggested solution, either alternating current or direct current can be distributed to electric appliances or apparatuses with universal current properties.

The difficult problem with the formation of sparks at switch-on and especially at switch-off of a direct current determined by a load has been solved.

With that, direct current can be safely introduced for public use.

No risk of fire being related to outlet contacts for direct current or universal current exists any more.

No wear being related to sparks occurs in e g wall-mounted switches or other switches.

Use of universal current would substantially increase the flexibility and robustness of the use and distribution of electricity and, accordingly, the robustness of the community from a general point of view.

Apart from the fact that the invention offers a unique circuitry for an interlocking circuit and a unique control of the load currents by a voltage supplied unit, the invention offers an electronic tripping or fusing element in the form of an over-current protection by means of very small supplements to the interlocking circuit.

### BRIEF DESCRIPTION OF THE FIGURES

Some, at present suggested, embodiments of electronic elements in accordance with the present invention will now be described with a reference to the attached figures, where

FIG. 1 shows an outline of a suggested circuitry with an electronic element and, in FIG. 1a, elucidates the function as related to time of an interlocking circuit in the form of an electronic element during the switch-on to a load, illustrated in a current versus time diagram, while the switch-off of a connected load is illustrated in a current versus time diagram as per FIG. 1b,

FIG. 2 shows a suggested implementation of a circuit solution for said interlocking circuit, in an implementation for an electronic switch-on or switch-off of an alternating current in a plug, switch, wall-mounted switch etc in accordance with the invention,

FIG. 3 shows an example of an interlocking circuit in an implementation with a cord having a plug at each end, according to the invention, implying that that a current can be reduced and cut off before any of the contact devices of the cord are fully pulled away from their opposite contacts of a wall-mounted socket or an appliance or apparatus, where the cord and its contact devices are indicated in a dotted outline and where the circuit having the switch-on and switch-off function can be located free of choice in either of the two contact devices,

FIGS. 4 and 5 each show an alternating current implementation based on putting in (or pulling out) a mechanical control element related to the interlocking circuit,

FIG. 6 shows an example of the principle of current control of a cut-off function within the interlocking circuit used as an electronic tripping or fusing element in the form of a over-current protection, e g as an electronic tripping or fusing unit or switch, where the circuit in this implementation is fitted for or adapted for a low current intensity,

FIG. 7 shows a circuit, according to FIG. 6, supplemented with parallel connected transistors for an implementation fitted for high current intensity,

FIG. 8 shows a circuit fitted for or adapted for direct current, corresponding to that in FIG. 4 and

FIG. 9 shows current-voltage graphs for a MOSFET transistor connected in parallel with an IGBT transistor, applicable in each of the above indicated implementations, however more precisely illustrated in FIG. 7, and where the voltage in the graph means the conducting state voltage drop between the supply and the load.

### DESCRIPTION OF AN EMBODIMENT SUGGESTED AT PRESENT

By way of introduction it is emphasized that we, in the following description of an at present suggested implementation, showing the distinctive features associated with the invention and being made clear by the figures shown in the following drawings, have selected terms and a special terminology with the intention to, in the first place, have the inventive concept made clear.

In this context it shall however be observed that the expressions used here must not be regarded as being limiting to the terms chosen and used here only, but it shall be implied that each thus chosen term shall be interpreted to be additionally including all technical equivalents working or functioning in the same or essentially the same way in order to achieve the same or essentially the same intention and/or technical effect.

Thus the FIG. 1 shows, schematically and logically, a circuitry 1 with a unit 2, the latter switching on and/or switching off a load 1c.

Here, the unit 2 is controlled by means of a manual control bar 2′ that in a pressed down position switches on a supply voltage to the load 1c and in the shown position switches off the voltage from the load 1c, via an element 2a.

The purpose of the invention is to offer a switch-on, switch-off or disconnection, free from sparks and arcs, of the load 1c via the unit 2.

For this purpose, the use of an electronic circuitry or an electronic element 2a for control of the load current “Ib” is assigned.

More specifically, in the FIG. 1 is illustrated an electronic element 2a, fitted for and adapted for an electric circuitry or circuit arrangement 1, where said circuitry inter alia shall comprise a voltage source 1a, 1b, a supply voltage (and a supply current) feeding a unit 2 switching in or switching off a load 1c, and an interlocking circuit connected between the unit and the load, the interlocking circuit assigned a function fitted for switching on or switching off a load current, in order to achieve a switch-on or switch-off free from sparks or arcs of the load current via said unit 2 and said element 2a.

Said interlocking circuit or the element 2a is structured as an electronic element, and a switch-on of voltage to said electronic element 2a causes an activation of the circuits belonging to the element in order to, after the switch-on of voltage and after a trigger signal, cause an increase as a function of time of the load current, from a zero level “Io” to a level “Ib” corresponding to full power of said load.

In addition, said interlocking circuit 2a and its electronic elements are fitted or adapted to, after a trigger signal, cause an inactivation of the circuits belonging to the element in order to reduce, as a function of time, the full load current “Ib” to said load 1c towards and to zero level “Io” before said unit 2 causes the switch-off of the supply of current “Im” and voltage necessary for the circuits and components within the element 2a.

Said unit 2, switching on or switching off voltage and current to a load 1c, is fitted or adapted to offer a step by step switch-oh or a step by step switch-off of current, by at least two sequential steps.

More specifically it is assigned and suggested that for a switch-on of current (illustrated in figure la) a first step is activated at the point of time “t1”, fitted to cause the activation of circuits belonging to the element by a low auxiliary current “Im” and a full voltage level “V”, and after that, via a trigger signal 2b, a second step is activated, at the point of time “t2”, fitted or adapted to cause an increase of the load current as a function of time, from a zero level “Io” to said load value “Ib”.

For a switch-off (illustrated in FIG. 1b) of the load current “Ib” a first step is activated, at the point of time “t3”, fitted to, via a trigger signal 2b′, cause the inactivation of circuits belonging to the element, the circuits being fitted or adapted to reduce, as a function of time, the full load current “Ib” to said load 1c towards and to zero level “Io” (however +“Im”), and after that, at the point of time “t4”, a second step is activated, fitted or adapted to fully cut out the supply voltage and the auxiliary current “Im” related to it, the value and effect of the latter being ignored in the shown embodiments.

Specifically, the invention implies that circuits belonging to the element are mutually fitted and adapted to offer the assigned functions via what is called a universal current.

In this context it is especially implied that said circuits belonging to the element are furnished with, in a direct current application, only one semiconductor element connected in series, such as a selected transistor element with low internal resistance in the current conducting state.

Said circuits belonging to the element are furnished with, in an alternating current application, two semiconductor elements connected in series, such as two transistor elements with suitable, low internal resistance.

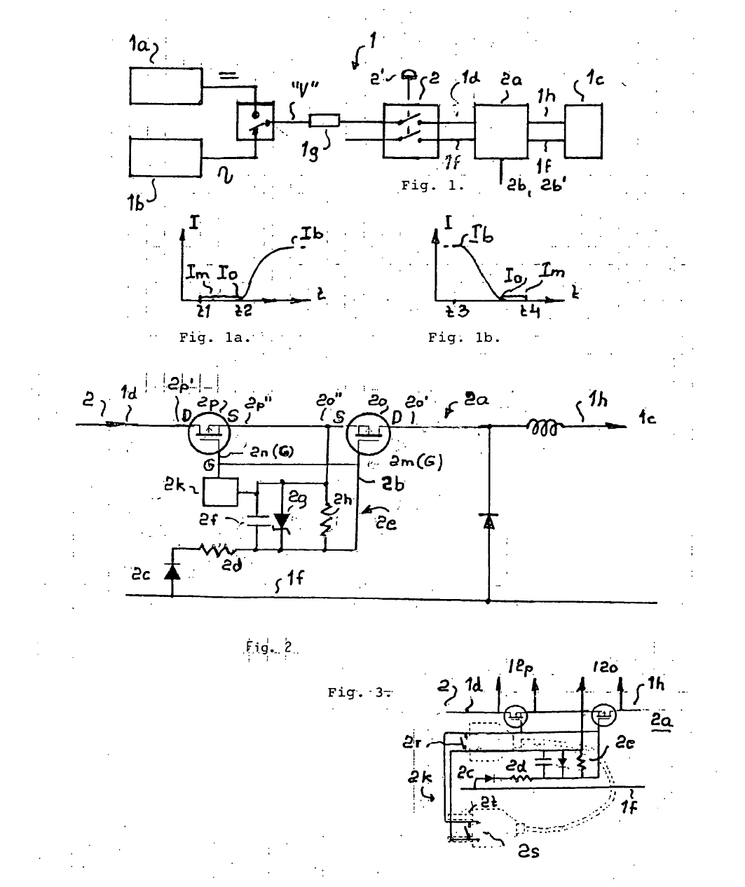

In accordance with the embodiment of the invention, the use of an especially designed interlocking circuit 2a is offered, which, according to FIG. 2, shall comprise at least one MOSFET transistor 2o, in the case of a direct current application, and at least two series connected MOSFET transistors 2o, 2p, in an alternating current application, the transistor terminals being connected in series to said load 1c and where an activating control signal or trigger signal 2b from or to a control device 2k shall be connected to the gate terminal of the transistor, designated “G”.

Said activating control signal 2b or 2b′ may, according to the embodiment shown in FIG. 2, be generated via a diode 2c, connected in series with a resistor 2d and a control unit 2e, but be triggered by a control device 2k.

The control unit 2e comprises a circuit with a connection in parallel of a capacitor 2f, a zener diode 2g and a resistor 2h, connected in series with said resistor 2d and said control device 2k.

The control device 2k is series connected between said parallel connected circuit and a gate terminal 2m(G).

In case said voltage source 1b is an alternating voltage, control units 2e shall interact with two series connected MOSFET transistors 2o and 2p, whose anode terminal 2o′ and cathode terminal 2o″ are connected in series with said load 1c.

The cathode terminal 2o″ of the transistor 2o is connected to the cathode terminal 2p″ of the other transistor 2p.

It should be observed that the indicated MOSFET transistors 2o and 2p have a structure-dependent limitation of the current flow, and in order to increase the permissible current of the element it is possible to use current shunting semiconductor elements (12o, 12p) connected in parallel with said transistors 2o and 2p respectively.

With reference to FIG. 7, it is shown that an IGBT transistor 12o, 12p is connected in parallel with said transistor assigned MOSFET transistors 2o and 2p respectively in order to increase the working range, and, accordingly, the current-voltage graph illustrates how the transistors 2p and 2o are conducting at low current intensity and voltage and how the transistors 12o and 12p shall be conducting and offer shunting of current at high current intensity and voltage.

The interlocking circuit 2a is arranged not to require a particular internal voltage producing unit for generation of necessary control voltages to the used semiconductor elements 2o, 2p, but the control voltages appear when the supply voltage “V” is connected via the unit 2.

The interlocking circuit 2a shall, when being supplied with voltage, be apt to be controlled by the trigger signal and by sensors related to control devices 2k of different kinds, which sensor or sensors may e g detect whether a connecting device is switched on or switched off, or, alternatively, may be arranged to cause, by means of other criteria, the determination whether a current shall be switched on or switched off.

The sensor and the control device 2k may comprise an electronic circuit and/or be controlled by a computer having means of communication, in order to, by means of these, generate an activating or triggering signal corresponding to the selected criterion.

The connecting device or the unit 2 may then, as a suitable example of embodiment, consist of a connecting device divided into two parts, e g a plug, a cord having a plug at both ends or a switching device, e g a breaker, a switch or an electronic tripping or fusing element serving as an over-current protection.

The interlocking circuit 2a is fitted or adapted to be furnished, free of choice, with an interference protection, a transient protection and/or an EMI filter of an in itself known design and connection.

The connecting element 2 and especially the circuit 2a consist, in an alternating current implementation 1b, of two semiconductor elements or sets of elements counter-connected in series, such as MOSFET transistors 2o, 2p, in this case assigned for jointing the two gate terminals 2n(G) and 2m(G) and the two cathodes 2o″(S) and 2p″(S).

The free anodes 2o″(D) and 2p″(D) respectively form the terminals of the circuit 2a to the supply side 1d and to the load side 1c respectively, with a connection free of choice.

In a direct current application la the polarity of the terminals 1d and 1h shall be negative and the terminal 1f be positive.

A return path 1f for A.C. and D.C. (positive) is formed by a through conduit.

When desired or required, a fusible cut-out 1g can be put into the circuit in accordance with FIG. 1.

In a multiphase application each phase should be furnished with such a circuitry and a unit 2 and a circuit 2a.

The control device 2k (the sensor or detecting device) may, in a suggested embodiment, consist of an electro mechanical micro switch (such as the one shown in the FIGS. 3, 4 and 5), but may also be an other type of sensor, free of choice, in order to detect the true put-in position of a contact device among a number of available ones.

The respective micro switches 2r and 2s in FIG. 3 are put into the open position for generation of the trigger signal when the male part is fully put into its counter-device, in doing which the circuit 2a (both the MOSFET transistors 2o and 2p) become conductive with low resistance.

The control current is received from the non-common side through the parasite diodes, not being shown in the figure, of the MOSFET transistors,.

In case the polarity, in a direct-current application, is inadvertently reversed, nothing will occur.

Only the MOSFET transistors 2o, 2p within a unit or a contact device 2 will be subject to appreciable heating and power loss.

The following arithmetical example illustrates this fact.

The power loss is calculated according to the following formula: Pₗₒₛₛ=2*Rds[on]*1².

With 100 million m (Rds[on]) MOSFET transistors and at a load current of 5 A, corresponding to a load of approx. 1.7 kW for a universal current appliance or apparatus with a supply voltage of 350 V, the Pₗₒₛₛ=2*0.1*5*5=5 W.

At a load current of 1 A, corresponding to a load of approx. 350 W for a universal current appliance, the Pₗₒₛₛ=2*0.1*1*1=0.2 W.

At a load current of 0.3 A, corresponding to a load of approx. 100 W for a universal current appliance, the Pₗₒₛₛ=2*0.1*0.3*0.3=0.018 W, i e 18 mW.

The MOSFET transistors 2o, 2p shall have a maximum allowed anode-cathode voltage exceeding the peak voltage including additional interference voltage.

The semiconductor switch design of the switching circuit 2a shall be adequate for the rated power of the appliance together with which it is to be used.

Furthermore, the circuit 2a should be furnished with per se known protection against interference and lightning, and it may also be furnished with an extra hf-EMI filter.

The failure modes of the unit 2 and the circuit 2a can be short-circuit between the supply and load sides or interruption.

Regarding the embodiment according to FIG. 2 and the next figures, the following sizes have been suggested.

The gate 2m(G) receives its voltage via a diode 2c and an approx. 200 kohm resistor 2d from the common lead 1f.

The failure mode here is interruption.

A capacitor 2f, a zener diode 2g and a discharge resistor 2h are loading the gate 2m(G) towards the cathode 2o″(S).

The capacitor 2f has the purpose of shunting the 50 Hz (or 60 Hz) pulses in the case of alternating voltage 1b.

The zener diode 2g limits the voltage to about 20 V, and the resistor 2h enables the MOSFET transistors 2o, 2p to cut off the current through the connecting element 2a after about 100 ms.

The above said control circuitry can be modified by use of another type of sensor, connected to the gate 2m(G).

Such a sensor will then control the above circuitry by removing the control voltage, i e either short-circuit or open the control voltage circuit.

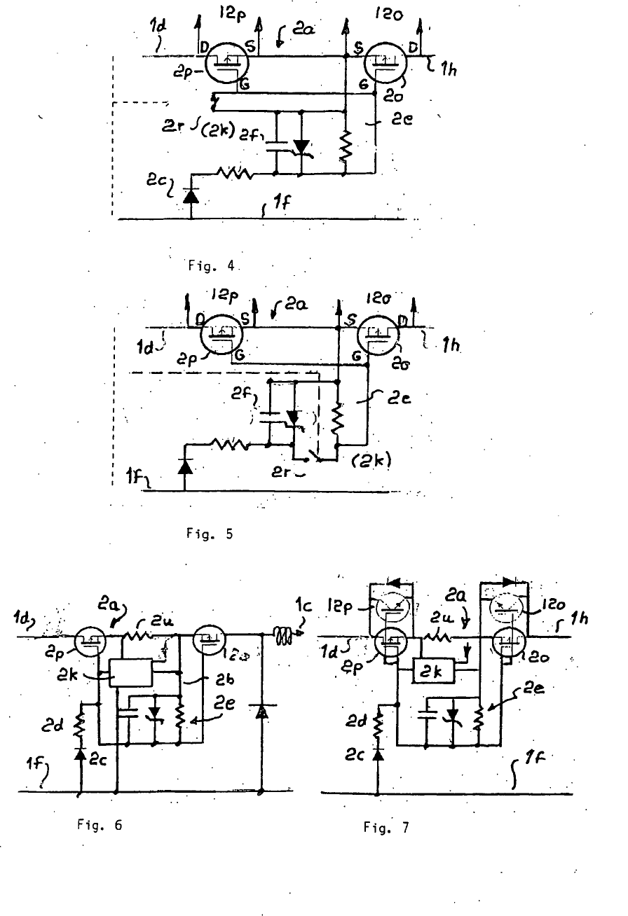

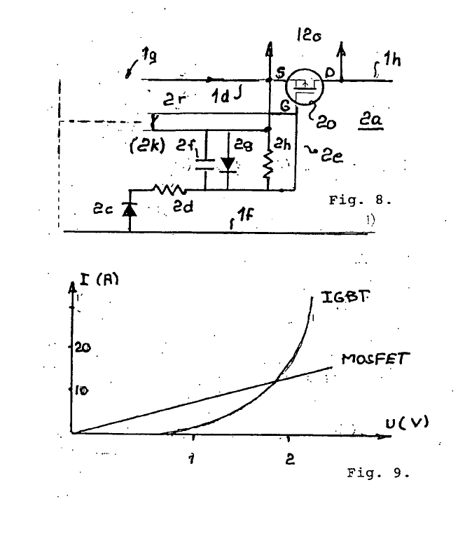

In case the plug is used with direct-current 1a only, the transistor 2p can be removed (be short-circuited according to the embodiment as per FIG. 8 as compared to the embodiment as per FIG. 4) and, accordingly, the power loss is then reduced by half according to the above mentioned calculation.

The FIGS. 3, 4 and 5 show the control of the circuit 2a with one or two alternatives for the location of contacts (micro switches, sensors) 2r, 2s for generation of trigger signals, with a reversed function of the control voltage.

As per FIG. 3, the circuit will block the current when the switch 2r is closed, and as per FIG. 5 the circuit will conduct current when the switch 2r is closed.

In the other position of the switches 2r, the opposite is valid.

FIG. 3 intends to show two contacts 2r and 2s, where the sensor of one of the contact devices controls another contact device having the same type of sensor. These may be connected as a stair switch.

The semiconductor circuits 2a can be integrated in either one or the other contact device.

These contact devices are located one in each end of a cord having an extra couple of leads 2t for the control.

In this figure, the contacts 2r, 2s are indicated by continuous lines.

The function may be such that is required to have both contact devices fully put into their respective counter-devices in order to make the respective contact 2r and 2s conducting and allowing current to flow through the cord.

This principle of making a switch-on or switch-off free of sparks, as per FIG. 6, also should be, in a somewhat supplemented form, suitable for use in a permanent electric installation as an electronic tripping or fusing element as an over-current protection.

This could be remote controlled by a position indicator via a transmission of information, by wire or wireless, from outlets or junctions where suitable.

FIG. 6 shows a circuitry having a current control function for e g an over-current protection in an electronic tripping element for low or moderate current, where the control device (the detecting device or sensor) 2k is controlled by the current through a shunting resistor 2u, connected between the feeding side 1d and the loading side 1c.

Here, the control device may consist of a double comparator or operational amplifier detecting the current through the shunt resistor 2u in both directions in the case of alternating current and influencing the control voltage and a trigger signal in order not to allow the current to exceed a specific value during a specific period of time.

The circuit can be made with hysteresis (latching) in order to minimize the power loss during the phase of cutting-off.

Furthermore, the control device 2k can be furnished with a trap function, i e be made to store the previous event.

This current-time function can be altered in order to achieve a different characteristic of e g an electronic tripping or fusing device or an over-current protection.

Furthermore, the control device 2k may, together with other circuits, include a computer circuit being able to store a number of data and also take part in the control function via the generation of different trigger signals. This way, a tripping element can be made programmable for different characteristics etc.

Additionally, it has the ability to detect the supplied current and power and calculate charging data and may thus be used as an electricity meter.

Insulated simplex communication to and from such a computer can also take place via the through lead 1f.

A manual cut-off function circuit for control of the over-current protection can be added to the circuit in the same way as shown in previous figures.

FIG. 7 shows in principle the same circuitry or circuit arrangement as FIG. 6, however changed so that the IGBT transistors 12o and 12p are fully parallel connected to the MOSFET transistors 2o and 2p. This configuration has, in the first place, been elaborated in order to make the circuitry short-circuit proof at high current level.

The high current acceptance and robustness of the IGBT transistors 12o and 12p makes them virtually take over the function of the coupling at high current levels. This happens however only during a short period of time at a switch-over when the coupling is set for delayed e g C-characteristics in order to manage high current during, most important, switch-on.

The two connected diodes in most cases are not necessary as the MOSFET transistors and the IGBT transistors both have integrated what is called parasite diodes.

Again referring to FIG. 1 and with a circuitry 2a in accordance with FIG. 4 the following function is obtained.

When the unit 2 is activated in order to connect the load 1c it is brought into a first, voltage supplying state, so that the circuit 2a is fed with an auxiliary current “Im” ( in the order of size of 10⁻³ A).

When the contact 2r is closed, the circuit 2a acts as an interruption in the circuitry.

By another displacement to a second position, opening the contact 2r, a trigger signal is given to the circuit 2a as a current conducting and current increasing circuitry from a zero level “Io” to a limited level “Ib” related to the load.

When the unit 2 is activated by a trigger signal for disconnection of the load 1c, it is displaced from the second position to the first position, so that the contact 2r is closed, and by this the circuit 2a is activated so that the supplied current is reduced from its full value “Ib” towards zero level “Io”, while the auxiliary current “Im” and full control voltage “V” are still fed to the circuit 2a.

Then the unit 2 can disconnect the load 1c without current flow and without formation of sparks.

The invention is of course not limited to the above embodiment, presented as an example, but may be subject to modifications within the scope of the invention idea, illustrated in the following patent claims.

In particular it should be observed that each unit and/or circuit shown can be combined with each other unit and/or circuit within the scope in order to achieve the desired technical function.

1. An electronic element, fitted for or adapted for an electric circuitry or circuit arrangement, where said circuitry inter alia comprises a voltage source, a supply voltage and a supply current for feeding a unit switching on or switching off a load, and an interlocking circuit connected between the unit and the load, assigned a function fitted or adapted for switch-on or switch-off of current, in order to achieve a switch-on or switch-off free from sparks or arcs of the load current of a selected load via said unit, characterized in that said interlocking circuit (2a) is structured as an electronic element and a switch-on of voltage (t1) to said electronic element (2a) causes an activation of circuits belonging to the element in order to, after the switch-on of voltage (“V”) and by a trigger signal (2b), cause an increase of the load current (“Ib”) to said load (1c) as a function of time.

2. An element as set forth in claim 1, characterized in that said interlocking circuit and its electronic element (2a) are fitted or adapted to, by a trigger signal (2b′), cause an inactivation of circuits belonging to the element in order to reduce the load current to said load as a function of time, before said unit causes the disconnection of the supply voltage.

3. An element as set forth in claim 1 or 2, characterized in that said unit, switching on or switching off the voltage and the current to a load, is fitted or adapted to initiate a step by step switch-on or step by step switch-off of current, in at least two steps.

4. An element as set forth in claim 1 or 3, characterized in that, for switching on current, a first step is activated, fitted or adapted to, by means of a low auxiliary current, cause an activation of circuits belonging to the element, and after that, a second step is activated by a trigger signal (2b), the second step being fitted to cause an increase as a function of time of the load current (“Ib”) to said load (1c).

5. An element as set forth in claim 1 or 2, characterized in that, for switching off the load current, a first step is activated by a trigger signal (2b′), the first step being fitted or adapted to inactivate circuits belonging to the element, the circuits being fitted or adapted to cause a reduction or switching off as a function of time the load current to said load, and after that, a second step is activated, fitted to switch off the supply voltage.

6. An element as set forth in claim 1, characterized in that the supply voltage is selected to be less than 1000V for A.C. or 1500 V for D.C.

7. An element as set forth in claim 1, characterized in that the circuits belonging to the element are fitted or adapted to offer the assigned functions via what is called universal current.

8. An element as set forth in claim 1 or 7, characterize in that said circuits belonging to the element are furnished with, in a direct current application, a series connected semiconductor element, such as a transistor element with low internal resistance.

9. An element as set forth in claim 1 or 7, characterized in that said circuits belonging to the element are furnished with, in an alternating current application, two semiconductor elements connected in series, such as two transistor elements with suitable, low internal resistance.

10. An electronic element fitted or adapted for an electric circuitry or circuit arrangement, in accordance with patent claim 1, where said circuitry comprises:
a. a voltage source (1a, 1b)
b. a switching unit (2), fitted for switching on or switching off a load (1c),
i. said load (1c),
j. an interlocking circuit (2a), which, at switch-on of the load (1c) and supplied with voltage and by means of an auxiliary current, is fitted or adapted to cause an increasing load current to be controlled in order to reduce the formation of sparks otherwise occurring in switching units and
k. an interlocking circuit, which, at the switch-off of the load (1c) and, supplied with voltage and by means of an auxiliary current, is fitted or adapted first to cause said circuit to be inactivated in order to cause the load current to be successively reduced and after that cause the supply voltage to be switched off, said interlocking circuit comprising at least one MOSFET transistor, whose anode and cathode terminals are connected in series with said load and where an activating control signal (2b) is connected to the gate terminal (G) of said transistor.

11. An element as set forth in claim 1 or 10, characterized in that said activating control signal (2b) is generated via a diode (2c), connected in series with a resistor (2d) and a control unit (2e).

12. An element as set forth in claim 1, 10 or 11, characterized in that a control unit (2e) comprises a circuitry with a capacitor (2f), a zener diode (2g) and a resistor (2h) connected in parallel, the circuit being connected in series with a resistor (2d) and a control device (2k).

13. An element as set forth in claim 1, 10, 11 or 12, characterized in that said control device (2k) is connected between said parallel connected circuit and a gate terminal.

14. An element as set forth in any of the previous claims, characterized in that said supply voltage is an alternating voltage and the control unit (2e) comprises two MOSFET transistors connected in series, whose anode and cathode terminals are connected in series with said load while the cathode terminal (2o″) of one transistor is connected to the cathode terminal (2p″) of the other transistor.

15. An element as set forth in claim 1, 10 or 14, characterized in that an IGBT transistor (12o, 12p) is connected in parallel with a MOSFET transistor assigned to said IGBT transistor.

16. An element as set forth in claim 1 or 10, characterized in that the interlocking circuit is fitted not to require a particular internal voltage producing unit in order to generate necessary control voltages to the employed and used semiconductor elements.

17. An element as set forth in claim 1 or 10, characterized in that the interlocking circuit is activated or inactivated by detecting devices or sensors, which detecting devices or sensors are fitted or adapted to cause the detection whether a unit is switched on or switched off or, alternatively, are fitted to, by means of other criteria, cause the determination whether a feeding current shall be connected or cut off.

18. An element as set forth in claim 17, characterized in that said detecting device is fitted or adapted to comprise an electronic circuit and/or a computer unit with an appurtenant possibility of communication for generating one or more trigger signals.

19. An element as set forth in any of the previous claims, characterized in that said unit is constituted by a contact device, such as a plug, a cord with a plug in each end or a switching device, such as a switch, a circuit closer, or an over-current protection within an electronic tripping or fusing unit.

20. An element as set forth in any of the previous claims, characterized in that, the interlocking circuit is adaptable to be furnished, free of choice, with an interference protection, a transient protection and/or an EMI filter.

21. An electronic tripping element fitted for an electric circuitry, where said circuitry inter alia comprises a voltage source, a supply voltage and a supply current to a unit switching on or switching off a load, and a tripping or fusing unit, characterized in that a tripping or fusing element in the form of an over-current protection comprises at least one semiconductor element, such as one or more MOSFET transistors whose anode and cathode terminals are connected in series with said load via a resistor (2u) and where an activating control signal (2b) is connected to the gate terminal (G) of the semiconductor element.

22. An element as set forth in claim 21, characterized in that the supply voltage is selected to be less than 1000 V for A.C. and 1500 V for D.C.

23. An element as set forth in claim 21, characterized in that the circuits belonging to the element are fitted or adapted to offer the assigned functions via what is called universal current.

24. An element as set forth in claim 21 or 23, characterized in that said circuits belonging to the element are furnished with, in a direct current application, a semiconductor element connected in series, such as a transistor element with low internal resistance.

25. An element as set forth in claim 21 or 23, characterized in that said circuits belonging to the element are furnished with, in an alternating current application, two semiconductor elements connected in series, such as two transistor elements with suitable, low internal resistance.

26. An element as set forth in claim 21, characterized in that the over-current protection comprises at least one MOSFET transistor having its anode and cathode terminals connected in series with said load and where an activating control signal (2b) is connected to the gate terminal (G) of said transistor.

27. An element as set forth in claim 21, characterized in that an activating control signal (2b) is generated via a diode (2c), connected in series with a resistor (2d) and a control unit (2e).

28. An element as set forth in claim 21, characterized in that a control unit (2e) comprises a circuit consisting of a capacitor (2f), a zener diode (2g) and a resistor (2h) connected in parallel, the circuit being connected in series with a resistor (2d) and a control device (2k).

29. An element as set forth in claim 21, characterized in that a control device (2k) is connected between said circuit with parallel configuration and a gate terminal.

30. An element as set forth in any of the previous claims 21 to 29, characterized in that a supply voltage is an alternating voltage and where the control unit (2e) comprises two MOSFET transistors connected in series, having the anode and cathode terminals connected in series with said load, while the cathode terminal of one transistor is connected to the cathode terminal of the other transistor.

31. An element as set forth in claim 21 or 30, characterized in that an IGBT transistor (12o, 12p) is connected in parallel with a MOSFET transistor assigned to said IGBT transistor.

32. An element as set forth in claim 21 or 26, characterized in that the over-current protection is fitted not to require a separate internal voltage producing unit for generating the necessary control voltages to the employed semiconductor elements.

33. An element as set forth in claim 21, characterized in that the over-current protection is activated or inactivated by detecting devices, the detecting devices being fitted or adapted to detect whether a unit is switched on or switched off, or, alternatively, is arranged to, by means of other criteria, cause the determination whether a feeding current shall be connected or disconnected.

34. An element as set forth in claim 33, characterized in that said detecting device is fitted or adapted to comprise an electronic circuit and/or computer unit with appurtenant possibilities of communication for generation of one or more trigger signals.

35. An element as set forth in any of the previous claims 21 to 34, characterized in that the over-current protection is adaptable to be furnished, free of choice, with an interference protection, a transient protection and/or an EMI filter.
